(19) United States
(12) Patent Application Publication
(10) Pub. No.: US 2024/0394228 A1
(43) Pub. Date: Nov. 28, 2024

(54) ENHANCED TECHNIQUES FOR ZERO-COPY

(71) Applicant: Level 3 Communications, LLC, Broomfield, CO (US)

(72) Inventor: William CROWDER, Camarillo, CA (US)

(73) Assignee: Level 3 Communications, LLC, Broomfield, CO (US)

(21) Appl. No.: 18/441,997

(22) Filed: Feb. 14, 2024

Related U.S. Application Data
(60) Provisional application No. 63/504,645, filed on May 26, 2023.

(51) Int. Cl. G06F 16/185; G06F 16/14

(52) U.S. Cl. CPC G06F 16/185; G06F 16/148

(57) ABSTRACT

This disclosure describes systems, methods, and devices related to requesting use of a zero-copy operation. A method may include: generating, by a first channel of a hierarchy of channels in a user space, a request to retrieve a file descriptor before initiating a zero-copy operation; sending, by the first channel, to the hierarchy, the request; identifying, by a second channel of the hierarchy, a response accepting the request, the response including the file descriptor; adding, by the second channel, additional information to the response accepting the request, the additional information including at least one of a need notify request to be notified of an amount of data transferred using the zero-copy operation or parsed body data; identifying, by the first channel, the file descriptor and the additional information; and initiating, by the first channel, based on identifying the file descriptor, the zero-copy operation.

### CROSS-REFERENCE TO RELATED APPLICATION

This application is related to and claims priority under 35 U.S.C. § 119 (e) from U.S. Patent Application No. 63/504,645, filed May 26, 2023, titled “ENHANCED TECHNIQUES FOR ZERO-COPY,” the entire content of which is incorporated herein by reference for all purposes.

This application incorporates by reference U.S. patent application Ser. No. 14/302,944, filed Jun. 12, 2014, and issued on Dec. 6, 2016 as U.S. Pat. No. 9,516,136, titled “CUSTOMER-SPECIFIC REQUEST-RESPONSE PROCESSING IN A CONTENT DELIVERY NETWORK,” the entire content of which is incorporated herein by reference for all purposes.

### TECHNICAL FIELD

Embodiments of the present invention generally relate to devices, systems, and methods for enhanced zero-copy techniques.

### BACKGROUND

When data traverses between the user space and the kernel space, the data are copied, requiring significant processing cycles and memory. Zero-copy reduces the number of copies needed between kernel and user space.

### SUMMARY

A method of requesting use of a zero-copy operation may include: generating, by a first channel of a hierarchy of channels in a user space, a request to retrieve a file descriptor before initiating a zero-copy operation associated with copying the file descriptor in a kernel space; sending, by the first channel, to the hierarchy, the request to retrieve the file descriptor; identifying, by a second channel of the hierarchy, a response accepting the request to retrieve the file descriptor, the response including the file descriptor; adding, by the second channel, additional information to the response accepting the request to retrieve the file descriptor, the additional information including at least one of a need notify request to be notified of an amount of data transferred using the zero-copy operation or incidentally read (e.g., not parsed, but read in the process of parsing HTTP headers) body data; identifying, by the first channel, based on the request to receive the file descriptor, the file descriptor and the additional information; and initiating, by the first channel, based on identifying the file descriptor, the zero-copy operation. The request for the file descriptor may be accepted or denied. When denied (e.g., because an intermediate channel needs to inspect and/or modify the body data itself), the denial may be propagated through the hierarchy to the client channel, which may then continue a buffered transfer.

A device for requesting use of a zero-copy operation may include memory coupled to at least one processor to: generate, by a first channel of a hierarchy of channels in a user space, a request to retrieve a file descriptor before initiating a zero-copy operation associated with copying the file descriptor in a kernel space; send, by the first channel, to the hierarchy, the request to retrieve the file descriptor; identify, by the first channel, based on the request to receive the file descriptor, the file descriptor and additional information provided by one or more additional channels of the hierarchy, the additional information including at least one of a need notify request to be notified of an amount of data transferred using the zero-copy operation or incidentally read (e.g., not parsed, but read in the process of parsing HTTP headers) body data; and initiate, by the first channel, based on identifying the file descriptor, the zero-copy operation. The request for the file descriptor may be accepted or denied. When denied (e.g., because an intermediate channel needs to inspect and/or modify the body data itself), the denial may be propagated through the hierarchy to the client channel, which may then continue a buffered transfer.

A system for requesting use of a zero-copy operation may include: a hierarchy of channels in a user space, the hierarchy of channels including a first channel and a second channel, wherein the hierarchy of channels further includes memory coupled to at least one processor to: generate, by the first channel, a request to retrieve a file descriptor before initiating a zero-copy operation associated with copying the file descriptor in a kernel space; send, by the first channel, to the hierarchy, the request to retrieve the file descriptor; identify, by the second channel, a response accepting the request to retrieve the file descriptor, the response including the file descriptor; add, by the second channel, additional information to the response accepting the request to retrieve the file descriptor, the additional information including at least one of a need notify request to be notified of an amount of data transferred using the zero-copy operation or incidentally read (e.g., not parsed, but read in the process of parsing HTTP headers) body data; identify, by the first channel, based on the request to receive the file descriptor, the file descriptor and the additional information; and initiate, by the first channel, based on identifying the file descriptor, the zero-copy operation. The request for the file descriptor may be accepted or denied. When denied (e.g., because an intermediate channel needs to inspect and/or modify the body data itself), the denial may be propagated through the hierarchy to the client channel, which may then continue a buffered transfer.

### BRIEF DESCRIPTION OF THE DRAWINGS

FIG. 1 illustrates exemplary processes for data transfer using zero-copy and without using zero-copy in accordance with one embodiment.

FIG. 2 illustrates an example process using zero-copy with a get file descriptor request accepted for a channel hierarchy in accordance with one embodiment.

FIG. 3 illustrates an example process using zero-copy with a get file descriptor request denied for a channel hierarchy in accordance with one embodiment.

FIG. 4 is a flowchart illustrating a process for using zero-copy in a network with a hierarchical framework in accordance with one embodiment.

FIG. 5 is a diagram illustrating an example of a computing system that may be used in implementing embodiments of the present disclosure.

### DETAILED DESCRIPTION

Aspects of the present disclosure involve devices, systems, methods, and the like, for enhanced zero-copy techniques.

When data transfers between the user space and kernel space, it is copied, requiring CPU cycles and memory bandwidth. In particular, the kernel reads data off a source and pushes it across the kernel-user boundary to an application, then the application pushes the data back across the kernel-user boundary, so the application acts as an intermediary. To reduce copying between kernel and user space (e.g., memory spaces), zero-copy techniques allow the user space to orchestrate movement of data such that the data may remain in the kernel space without having to be copied to the user space. When an application uses zero-copy, it may request the kernel to copy data directly from a source without going through the application in the user space. Zero-copy is an important technique in high-performance servers, for example.

When a channel, such as the client channel in user space, intends to use zero-copy, the client channel needs the file descriptor (e.g., the source file descriptor), and retrieves the file descriptor. However, in a hierarchy of channels, such as when a transfer monitor and HTTP parser are between the client channel and the source channel, the client channel may not be able to enter zero-copy mode because the other channels in the hierarchy may have data that the client channel needs to write to the client file descriptor before entering zero-copy mode. For example, the HTTP parser may have the headers and at least partial body data, and the headers need to be parsed. The transfer monitor may need to be notified of a transfer request (e.g., such as in a HTTP keep-alive scenario). The client channel may be unaware of what other modules between the client channel and the source channel are doing, and vice versa. Accordingly, there may be additional information to be passed from the other channels to the client channel along with the file descriptor from the source channel so that the client channel may enter zero-copy mode. For example, HTTP body data incidentally read by the HTTP parser and/or a transfer notify request (e.g., a request to be notified of the results of the transfer) from the transfer monitor may need to be passed to the client channel. However, in such a channel hierarchy, the client channel currently has no way of receiving that additional information from the other channels in the hierarchy when the client channel attempts to use zero-copy.

Without zero-copy mode, the transfer monitor would see the transfers in the hierarchy, and the incidentally read body data would be provided by the channel performing HTTP header parsing. However, when zero-copy mode is used, the transfer monitor and the HTTP parser are bypassed, as the client channel would issue a request for the source channel file descriptor, and the client channel would enter zero-copy mode after receiving and writing the file descriptor. As a result, if another channel in the pipeline has information to pass to the client channel prior to the client channel entering zero-copy mode, that information may not be passed to the client channel. Accordingly, the transfer monitor may not be notified of the results of the transfer, and the HTTP parser may have body data that may not be written prior to the client channel entering zero-copy mode.

In one or more embodiments, when a client channel in a channel hierarchy intends to enter zero-copy mode, prior to doing so, may generate and send a get-fd (get file descriptor) request through the channel hierarchy so that any channel in the hierarchy may see the request and add their data to the response to be provided to the client channel prior to the client channel entering zero-copy mode. For example, the channels of the hierarchy may be modular and provide different services, such as a HTTP parser that parses messages, and a transfer monitor that may need to be notified of an amount of data being transferred. Before the client channel enters zero-copy mode, the HTTP parser may add the body data to the get-fd response, and/or the transfer monitor may add a transfer notify request to the response so that the transfer monitor is notified of the amount of data transferred. The channels of the hierarchy may receive the get-fd request and pass it to the next channel in the hierarchy. When the get-fd request is accepted by all the channels in a pipeline (e.g., from the client channel to the source channel), the source fd and any additional information from the other channels may be returned to the client channel. When the get-fd request is denied, the denial should be returned to the client channel, and the get-fd request should not need to be cascaded past the channel that issues the denial. When the get-fd request is denied by another channel, a channel that sees the denial should not add its information to the response because there may be no need.

The decision whether to allow get-fd request to succeed may be made at each channel in the pipeline when the request is received. Further, the mere receipt of the request must not modify the channel state, i.e., the channel must be able to resume normal operation in the case where some other channel denies the get-fd request. Once a channel has allowed a get-fd request to pass through it without denying the request, then the channel must be prepared to add whatever data is necessary to the response to the get-fd request. There may be no second chance to respond: If a channel has decided to allow get-fd, the channel should be be prepared to add whatever it needs, if anything, to the response, and may not decide on the response side to deny the request because the other channels in the pipeline have already modified their state in response to the successful get-fd response that they identify.

The enhanced techniques herein are particularly useful when maintaining separation of concerns in programming When the channels in the hierarchy maintain separation of concerns, they may be unaware of the code of the other channels. As a result, the channels may not be aware of what the other channels are doing, and therefore that the channels have data or needs to be met prior to entering zero-copy mode. The enhancements herein allow for maintaining modular coding with separation of concerns while ensuring that channels coordinate when zero-copy mode is requested.

The above descriptions are for purposes of illustration and are not meant to be limiting. Numerous other examples, configurations, processes, etc., may exist, some of which are described in greater detail below. Example embodiments will now be described with reference to the accompanying figures.

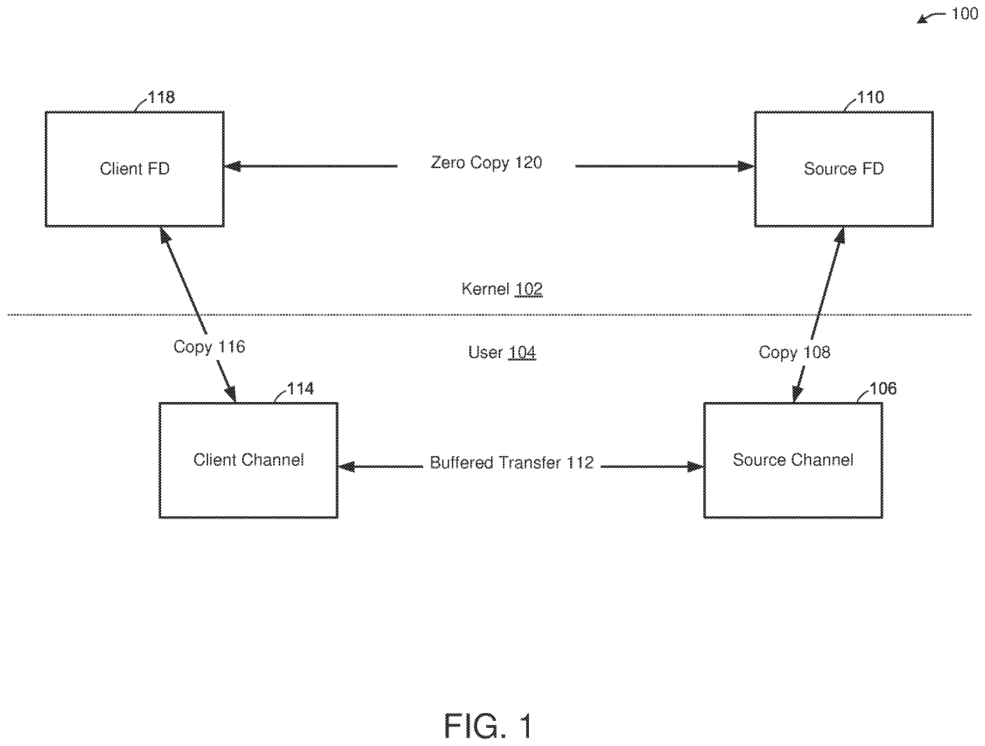

FIG. 1 illustrates exemplary processes for data transfer using zero-copy and without using zero-copy in accordance with one embodiment.

Referring to FIG. 1, kernel space 102 and user space 104 are shown. A source channel 106 may copy 108 from a source fd 110, moving the data from the kernel space 102 to the user space 104. A buffered transfer 112 in the user space 104 may copy the data from the source channel 106 to a client channel 114. The data may be copied 116 from the client channel 114 in the user space 104 to a client fd 118 in the kernel space 102. Such represents a data transfer without zero-copy. However, when zero-copy 120 is used, the data may be copied between the source fd 110 and the client fd 118 without the data being transferred from the kernel space 102 to the user space 104, and back to the kernel space 102.

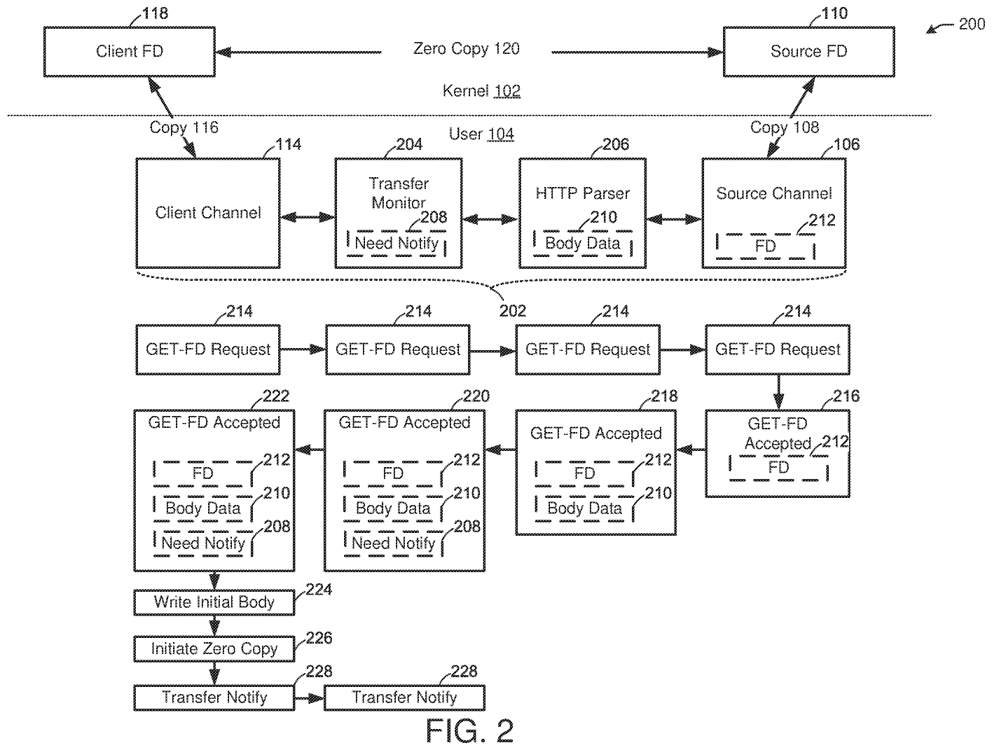

FIG. 2 illustrates an example process 200 using zero-copy with a get file descriptor request accepted for a channel hierarchy in accordance with one embodiment.

Referring to FIG. 2, a channel hierarchy 202 (e.g., representing a pipeline of channels) may include the client channel 114 and the source channel 106 of FIG. 1, and also may include modular channels such as a transfer monitor 204 (e.g., for monitoring the amount of data transferred to the client channel 114, from the source channel 106, or both) and a HTTP parser 206 (e.g., for parsing message data, including headers and body data of the message). The transfer monitor may provide a need notify attribute 208 (e.g., need notify request, as explained further below) indicating its need to monitor the amount of data transferred, and the HTTP parser 206 may provide body data 210 (e.g., initial body data incidentally read during the HTTP message parsing process. When the client channel 114 intends to use zero-copy mode (e.g., to avoid the copying 116 from the user space 104 to the kernel space 102), the client channel 114 may generate and send a get-fd request 214 (e.g., using an application programming interface shared by the channels in the channel hierarchy 202) to request a fd 212 from the source channel 106. The transfer monitor 204 may receive the get-fd request 214, and if the transfer monitor 204 does not deny the get-fd request 214, the transfer monitor 204 may pass the get-fd request 214 to the HTTP parser 206. If the HTTP parser 206 does not deny the get-fd request 214, the HTTP parser 206 may pass the get-fd request 214 to the source channel 106.

Still referring to FIG. 2, when the get-fd request 214 reaches the source channel 106 and is not denied by the source channel 106 (e.g., sometimes there may not be a source fd to return), the source channel 106 may accept the get-fd request 214, responding 216 with the fd 212, which may be propagated through the channel hierarchy 202. When the HTTP parser 206 identifies the response from the source channel 106 including the fd 212 (e.g., not denying the get-fd request 214), the HTTP parser 206 may add the body data 210 to the response 216 (e.g., resulting in a response 218) when the HTTP parser 206 has the body data 210 to be returned to the client channel 114. The response 218 with the fd 212 and the body data 210 may be propagated to the transfer monitor 204. When the transfer monitor 204 identifies the response 218 as not denying the get-fd request 214, the transfer monitor 204 may add the need notify attribute 208 to a response 218 (e.g., resulting in a response 220). The response 220 may be propagated to the client channel 114, providing the fd 212, the body data 210, and/or the need notify attribute 208 to the client channel 114. As a result, the client channel 114 may write the initial body data 210 prior to initiating a zero-copy operation 226, and then may send a transfer notify message 228 to the transfer monitor 204 to communicate the amount of data being transferred in the zero-copy 226 operation.

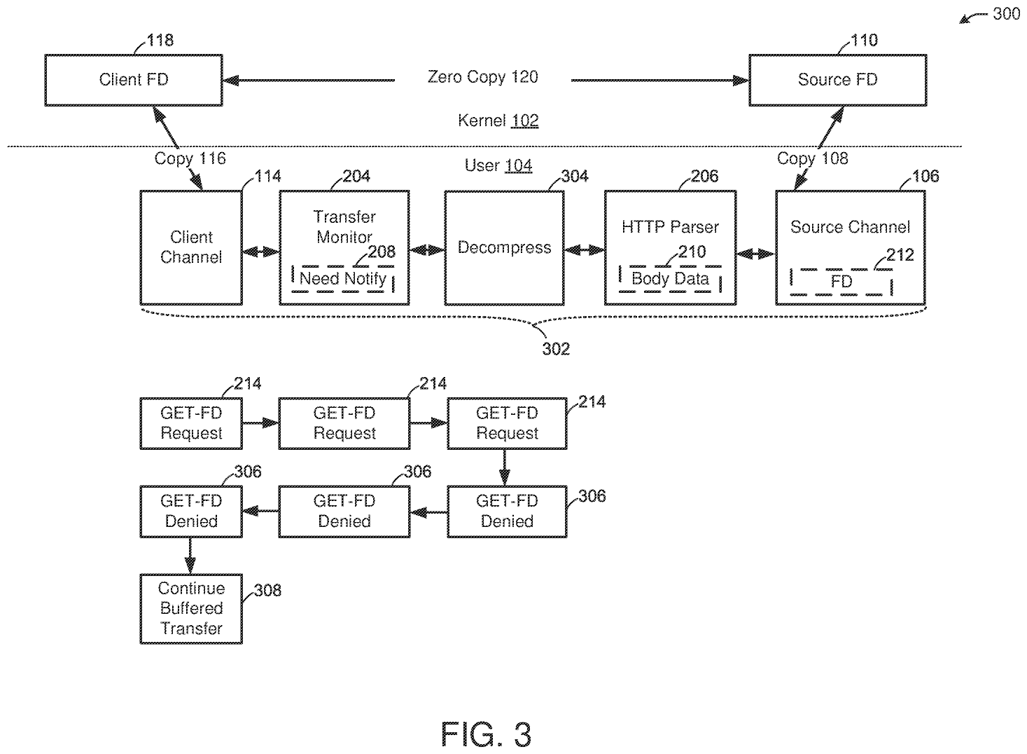

FIG. 3 illustrates an example process 300 using zero-copy with a get file descriptor request denied for a channel hierarchy in accordance with one embodiment.

Referring to FIG. 3, the process 300 shows how the process 200 of FIG. 2 may allow for the get-fd request 214 may be denied at some channel. In FIG. 3, a channel hierarchy 302 adds decompress modules 304 to the channel hierarchy 202 of FIG. 2. Similar to the process 200 of FIG. 2, the client channel 114 may generate and send the get-fd request 214 through the channel hierarchy 302. Any of the channels (e.g., the transfer monitor 204, the decompress modules 304, the HTTP parser 206, the source channel 106) may deny the get-fd request 214. Once the get-fd request is denied, the denying channel should send a denial response to be propagated back to the client channel 114, and the get-fd request 214 should not be propagated further down the channel hierarchy 302 (e.g., to prevent an inconsistent state of the channels in which some channels allow the get-fd request 214). In the example shown in FIG. 3, the get-fd request 214 is accepted by the transfer monitor 204 and reaches the decompress modules 304, which may deny the get-fd request 214. The decompress modules 304 may generate and send the denial 306 of the get-fd request 214 back up the channel hierarchy 302 to the transfer monitor 204. When a channel such as the transfer monitor 204 identifies the denial 306, the channel may not add the information that it may have to the response to the get-fd request 214. For example, the transfer monitor 204 may not add the need notify message 208 to the denial 306. Once the client channel 114 receives the denial 306, the client channel 114 may continue/initiate a buffered transfer 308 (e.g., not using zero-copy mode).

Referring to FIGS. 2 and 3, the channels in the channel hierarchy may maintain separation of concerns in programming When the channels in the hierarchy maintain separation of concerns, they may be unaware of the code of the other channels. As a result, the channels may not be aware of what the other channels are doing, and therefore that the channels have data or needs to be met prior to entering zero-copy mode. The enhancements herein allow for maintaining modular coding with separation of concerns while ensuring that channels coordinate when zero-copy mode is requested.

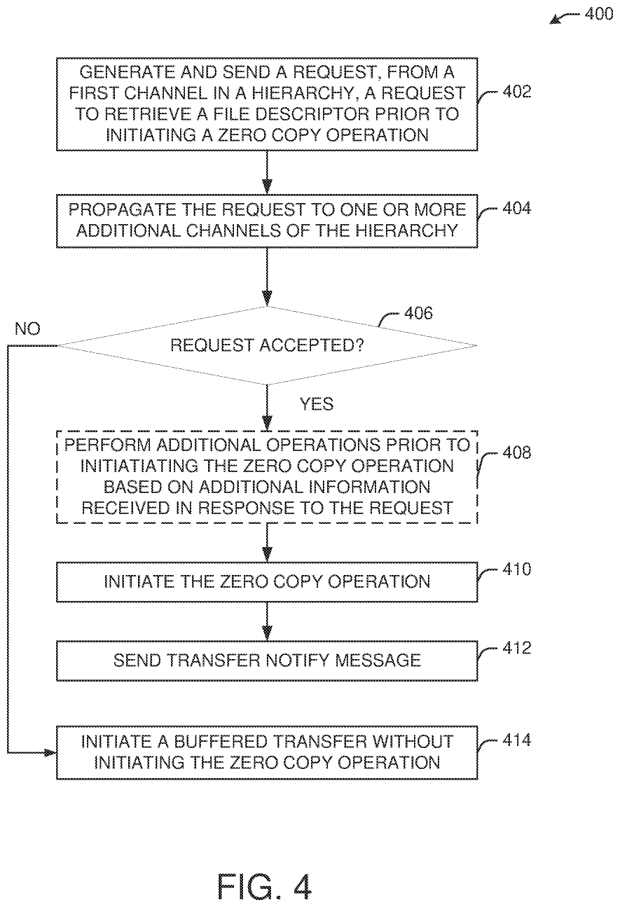

FIG. 4 is a flowchart illustrating a process 400 for using zero-copy in a network with a hierarchical framework in accordance with one embodiment.

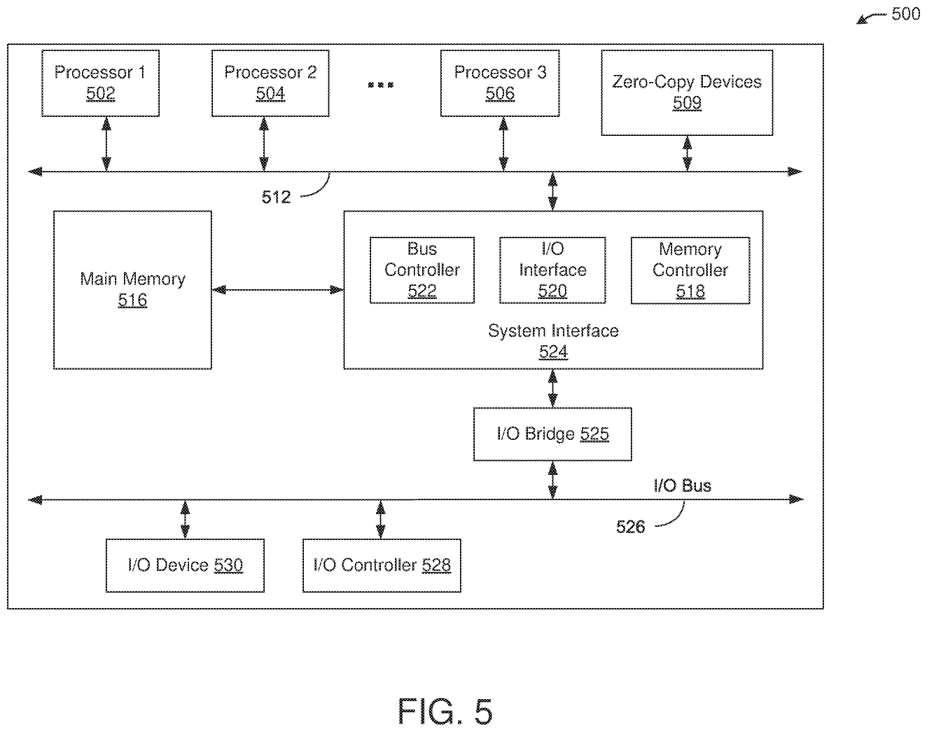

At block 402, a device (or system, e.g., the client channel 114 of FIG. 1, the zero-copy devices 509 of FIG. 5) may generate and send a request to retrieve a file descriptor (e.g., the get-fd request 214 of FIG. 2) prior to initiating a zero-copy operation. The device may send the request through a hierarchy of channels (e.g., the channel hierarchy 202 of FIG. 2, the channel hierarchy 302 of FIG. 3) in user space using an API shared by the channels. At block 404, the device may propagate the request by sending the request with the API such that a receiving channel in the hierarchy may pass the request to a subsequent channel in the hierarchy when the receiving channel does not deny the request. When a receiving channel denies the request, the denying channel should generate and send a response indicating the denial (e.g., the denial 306 of FIG. 3).

At block 406, the device may determine, based on the response, whether the request has been accepted and incidentally read the requested file descriptor, or whether the request has been denied. When the request is accepted, the device may proceed to block 408 where, optionally, the device may perform additional operations prior to initiating the zero-copy operation. The additional operations may be based on additional information in the response, such as parsed message body data (e.g., the body data 210 of FIG. 2), which the device should write prior to initiating the zero-copy operation at block 410.

At block 412, when the additional information includes a transfer notify request (e.g., the need notify message 208 of FIG. 2), the device may send a transfer notify message (e.g., the transfer notify message 228 of FIG. 2) to a transfer notify monitor to indicate the amount of data transferred in the zero-copy operation at block 410.

At block 414, when the response denies the request at block 406, the device may initiate or continue a buffered transfer without initiating the zero-copy operation.

It is understood that the above descriptions are for purposes of illustration and are not meant to be limiting.

FIG. 5 is a block diagram illustrating an example of a computing device or computer system 500 which may be used in implementing the embodiments of the components of the network disclosed above. For example, the computing system 500 of FIG. 5 may represent at least a portion of the system 100 of FIG. 1, and discussed above. The computer system (system) includes one or more processors 502-506 and one or more zero-copy devices 509 (e.g., representing the channel hierarchies in FIG. 2 and FIG. 3, and capable of performing any operations described with respect to FIGS. 1-4). Processors 502-506 may include one or more internal levels of cache (not shown) and a bus controller 522 or bus interface unit to direct interaction with the processor bus 512. Processor bus 512, also known as the host bus or the front side bus, may be used to couple the processors 502-506 with the system interface 524. System interface 524 may be connected to the processor bus 512 to interface other components of the system 500 with the processor bus 512. For example, system interface 524 may include a memory controller 518 for interfacing a main memory 516 with the processor bus 512. The main memory 516 typically includes one or more memory cards and a control circuit (not shown). System interface 524 may also include an input/output (I/O) interface 520 to interface one or more I/O bridges 525 or I/O devices with the processor bus 512. One or more I/O controllers and/or I/O devices may be connected with the I/O bus 526, such as I/O controller 528 and I/O device 530, as illustrated.

I/O device 530 may also include an input device (not shown), such as an alphanumeric input device, including alphanumeric and other keys for communicating information and/or command selections to the processors 502-506. Another type of user input device includes cursor control, such as a mouse, a trackball, or cursor direction keys for communicating direction information and command selections to the processors 502-506 and for controlling cursor movement on the display device.

System 500 may include a dynamic storage device, referred to as main memory 516, or a random access memory (RAM) or other computer-readable devices coupled to the processor bus 512 for storing information and instructions to be executed by the processors 502-506. Main memory 516 also may be used for storing temporary variables or other intermediate information during execution of instructions by the processors 502-506. System 500 may include a read only memory (ROM) and/or other static storage device coupled to the processor bus 512 for storing static information and instructions for the processors 502-506. The system outlined in FIG. 5 is but one possible example of a computer system that may employ or be configured in accordance with aspects of the present disclosure.

According to one embodiment, the above techniques may be performed by computer system 500 in response to processor 504 executing one or more sequences of one or more instructions contained in main memory 516. These instructions may be read into main memory 516 from another machine-readable medium, such as a storage device. Execution of the sequences of instructions contained in main memory 516 may cause processors 502-506 to perform the process steps described herein. In alternative embodiments, circuitry may be used in place of or in combination with the software instructions. Thus, embodiments of the present disclosure may include both hardware and software components.

A machine readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 506 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 516, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

What is claimed:

1. A method of requesting use of a zero-copy operation, the method comprising:
generating, by a first channel of a hierarchy of channels in a user space, a request to retrieve a file descriptor before initiating a zero-copy operation associated with copying the file descriptor in a kernel space;
sending, by the first channel, to the hierarchy, the request to retrieve the file descriptor;
identifying, by a second channel of the hierarchy, a response accepting the request to retrieve the file descriptor, the response comprising the file descriptor;
adding, by the second channel, additional information to the response accepting the request to retrieve the file descriptor, the additional information comprising at least one of a need notify request to be notified of an amount of data transferred using the zero-copy operation or incidentally read body data;
identifying, by the first channel, based on the request to receive the file descriptor, the file descriptor and the additional information; and
initiating, by the first channel, based on identifying the file descriptor, the zero-copy operation.

2. The method of claim 1, wherein the second channel is a transfer monitor device, and wherein the additional information comprises the need notify request.

3. The method of claim 2, further comprising:
sending, by the first channel to the transfer monitor device, a transfer notify message indicative of the amount of data transferred using the zero-copy operation.

4. The method of claim 1, wherein the second channel is a parser, and wherein the additional information comprises the incidentally read body data.

5. The method of claim 4, further comprising:
writing, by the first channel, the incidentally read body data prior to initiating the zero-copy operation.

6. The method of claim 1, further comprising:
identifying, by a third channel of the hierarchy, the response accepting the request to retrieve the file descriptor, the response comprising the file descriptor and the incidentally read body data;
adding, by the third channel, to the response accepting the request to retrieve the file descriptor, the need notify request to be notified of an amount of data transferred using the zero-copy operation.

7. The method of claim 1, further comprising:
identifying, by a third channel of the hierarchy, the response accepting the request to retrieve the file descriptor, the response comprising the file descriptor and the need notify request to be notified of an amount of data transferred using the zero-copy operation;
adding, by the third channel, to the response accepting the request to retrieve the file descriptor, the incidentally read body data.

8. The method of claim 1, further comprising:
generating, by the first channel, a second request to retrieve a second file descriptor before initiating a second zero-copy operation associated with copying the second file descriptor in the kernel space;
sending, by the first channel, to the hierarchy, the second request to retrieve the second file descriptor;
identifying, by the first channel, a second response denying the second request; and
initiating, by the first channel, based on the second response, a buffer transfer without initiating the second zero-copy operation.

9. The method of claim 8, further comprising:
identifying, by the second channel, the second response; and
sending, by the second channel, the second response without adding additional information to the second response.

10. A device for requesting use of a zero-copy operation, the device comprising memory coupled to at least one processor, wherein the at least one processor is configured to:
generate, by a first channel of a hierarchy of channels in a user space, a request to retrieve a file descriptor before initiating a zero-copy operation associated with copying the file descriptor in a kernel space;
send, by the first channel, to the hierarchy, the request to retrieve the file descriptor;
identify, by the first channel, based on the request to receive the file descriptor, the file descriptor and additional information provided by one or more additional channels of the hierarchy, the additional information comprising at least one of a need notify request to be notified of an amount of data transferred using the zero-copy operation or incidentally read body data; and
initiate, by the first channel, based on identifying the file descriptor, the zero-copy operation.

11. The device of claim 10, wherein the additional information comprises the need notify request.

12. The device of claim 11, wherein the at least one processor is further configured to:
send, by the first channel to a transfer monitor device, a transfer notify message indicative of the amount of data transferred using the zero-copy operation.

13. The device of claim 10, wherein the additional information comprises the incidentally read body data.

14. The device of claim 13, wherein the at least one processor is further configured to:
write, by the first channel, the incidentally read body data prior to initiating the zero-copy operation.

15. The device of claim 10, wherein the at least one processor is further configured to:
generate, by the first channel, a second request to retrieve a second file descriptor before initiating a second zero-copy operation associated with copying the second file descriptor in the kernel space;
send, by the first channel, to the hierarchy, the second request to retrieve the second file descriptor;
identify, by the first channel, a second response denying the second request; and
initiate, by the first channel, based on the second response, a buffer transfer without initiating the second zero-copy operation.

16. A system for requesting use of a zero-copy operation, the system comprising:
a hierarchy of channels in a user space, the hierarchy of channels comprising a first channel and a second channel, wherein the hierarchy of channels further comprises memory coupled to at least one processor, the at least one processor configured to:
generate, by the first channel, a request to retrieve a file descriptor before initiating a zero-copy operation associated with copying the file descriptor in a kernel space;
send, by the first channel, to the hierarchy, the request to retrieve the file descriptor;
identify, by the second channel, a response accepting the request to retrieve the file descriptor, the response comprising the file descriptor;
add, by the second channel, additional information to the response accepting the request to retrieve the file descriptor, the additional information comprising at least one of a need notify request to be notified of an amount of data transferred using the zero-copy operation or incidentally read body data;
identify, by the first channel, based on the request to receive the file descriptor, the file descriptor and the additional information; and
initiate, by the first channel, based on identifying the file descriptor, the zero-copy operation.

17. The system of claim 16, wherein the second channel is a transfer monitor device, and wherein the additional information comprises the need notify request.

18. The system of claim 17, wherein the at least one processor is further configured to:
send, by the first channel to the transfer monitor device, a transfer notify message indicative of the amount of data transferred using the zero-copy operation.

19. The system of claim 16, wherein the second channel is a hypertext transfer protocol (HTTP) parser, and wherein the additional information comprises the incidentally read body data.

20. The system of claim 19, wherein the at least one processor is configured to:
write, by the first channel, the incidentally read body data prior to initiating the zero-copy operation.
